(19) United States
(12) Patent Application Publication
(10) Pub. No.: US 2006/0012781 A1
(43) Pub. Date: Jan. 19, 2006

(54) Programmable spatial filter for wafer inspection

(75) Inventors: Keren Fradkin, Rehovot (IL); Noam Dotan, Givatayim (IL)

Correspondence Address: JULIAN H. COHEN;c/o LADAS & PARRY, 26 WEST 61ST STREET, NEW YORK, NY, 10023, US

(73) Assignee: NEGEVTECH LTD.

(21) Appl. No.: 10/890,800

(22) Filed: Jul. 14, 2004

(51) Int. Cl. G01N 21/88

(52) U.S. Cl. 356/237.5

(57) ABSTRACT

A programmable spatial filter for use as a Fourier plane filter in dark field wafer inspection systems, based on the use of MEMS (Micro-Electro-Mechanical Systems) devices. In comparison with prior art systems, especially those using LCD's, the use of MEMS devices provide a number of potential advantages, including good transmission in the UV, a high fill factor, polarization independence and a high extinction ratio since the shutter is opaque when closed. The MEMS devices can be flap devices, artificial eyelid, or double shutter devices. Additionally, a novel spatial light modulator (SLM) assembly having a double layer of SLM arrays is described, in which the fill factor is increased in comparison to a single layer SLM using the same devices, by positioning the dead areas of the elements of both arrays collinearly in the modulated beam. This SLM assembly can be implemented using pixelated LCD arrays or MEMS arrays.

### FIELD OF THE INVENTION

The present invention relates to the field of the use of programmable spatial filters based on the use of MEMS devices, especially for use as a Fourier plane filter in the imaging system of a wafer inspection system.

### BACKGROUND OF THE INVENTION

Wafer inspection systems are used in the semiconductor industry for the detection of small defects and anomalies occurring within the chips on the wafers, generally arising during the fabrication process. The geometry on a semiconductor wafer generally consists of a large-scale multiply repetitive pattern that defines the dies of the wafer. Within each die, there are often areas in which there appears an array of a repetitive pattern with a cycle of a few microns or less. This occurs especially in memory chips or in the memory area in a logic chip. The inspection system should be capable of detecting even defects occurring within these repetitive regions.

When coherent or partially coherent illumination is incident in a dark field configuration on such a repetitive array, the array serves as a diffraction grating that reflects the light at angles corresponding to the defined diffraction orders. The reflected light produces a diffraction pattern of spots in the back focal plane of the objective lens of the imaging system. This plane is also referred to as the Fourier plane of the lens, since the image obtained in this plane is a two-dimensional Fourier transform of the object. The smaller the cycle in the object plane, the larger the distance between the spots in the Fourier plane. The size of these spots depends on the optical quality of the objective lens, but even more on the geometrical nature of the incident light. When the input light is a collimated beam, the spot size is very small. Furthermore, certain known features of the wafer, even if non-repetitive, may scatter the incident light beam in known directions, which can be observed as known areas of the Fourier plane.

The system for the detection of wafer defects operates by looking for the very small anomalies resulting in the optical image information from such defects. These small anomalies usually appear as non-periodic, small signals, that override the medley of information that exists on the wafer. The light scattered from the repetitive structures on the wafer can be filtered in the Fourier plane, since it is concentrated only in certain specific areas, while the light from the defect can be spread over the entire Fourier plane. Similarly, the light scattered at certain selected angles, arising from known, not necessarily repetitive features on the wafer, can also be filtered in the Fourier plane. This task is facilitated by the use of a programmable Fourier plane filter.

In U.S. Pat. No. 5,970,168 to Montesanto et al., for “Fourier Filtering Mechanism for Inspecting Wafers” there is described the use of a spring array as a Fourier plane filter, with a built-in damping mechanism to prevent interference from mechanical vibrations. However, this prior art always relates to use of a laser as the light source, which is a collimated coherent light source.

In co-pending U.S. patent application Ser. No. 10/345,097, for “System for Detection of Wafer Defects”, commonly assigned with the present application, and herein incorporated by reference in its entirety, there are described Fourier plane filters using a mechanical array of small bars that can be physically moved by means of thin wires to change the cycle and phase of the mask in the Fourier plane. In that application, and elsewhere, the use of Spatial Light Modulators (SLM) using pixelated Liquid Crystal Displays (LCD) has been proposed for use as Fourier plane filters in wafer inspection systems. Such LCD SLM's are particularly useful as they may be programmed electronically to the Fourier plane pattern desired. However, many LCD materials do not stand up well to the UV illumination used in wafer inspection systems. In U.S. Patent Application Publication No. US-2003/0184739 to D. E. Wilk et al, for “UV Compatible programmable Spatial Filter”, and assigned to KLA-Tencor Technologies Corporation, there is described such an LCD programmable spatial filter using materials specially selected for use with ultra-violet illumination sources.

However, the use of any LCD array, regardless of the materials used, generally results in a limited transmission level in the regions which are switched to the “open” or transparent state, and a limited blocking level in the regions which are switched to the “closed” or opaque state. Additionally, changes in the polarization of the parts of the illuminating beam diffracted or scattered from the object may cause changes in the transmission and blocking properties of the LCD array, thus reducing its efficiency. Furthermore, even the most carefully selected materials, such as described in the above-mentioned Publication No. U.S. 2003/0184739, may eventually show deterioration in time under constant UV illumination.

There therefore exists a need for a new programmable spatial filter for use as a Fourier plane filter in wafer inspection systems, which will overcome some of the disadvantages of prior art filters.

The disclosures of each of the publications mentioned in this section and in other sections of the specification, are herein incorporated by reference, each in its entirety.

### SUMMARY OF THE INVENTION

The present invention seeks to provide, according to a first preferred embodiment, a dark field wafer inspection system, utilizing a programmable spatial Fourier plane filter based on the use of MEMS (Micro-Electro-Mechanical Systems) devices. In comparison with LCD prior art devices, MEMS devices have a number of potential advantages. Such advantages include:
(i) good transmission in the UV, of up to 95%, including the various layers of the device, since the devices can be fabricated on a high UV transmission substrate, such as fused silica;
(ii) a high fill factor, of up to 80% when suitable geometry is utilized;
(iii) polarization independence; since the light is either transmitted or blocked by means of the MEMS shutter, and not by any birefringence polarization rotation mechanism; and
(iv) a high extinction ratio, generally greater than 1000:1, since the shutter when closed is opaque.

A Fourier plane addressable filter according to the present invention, can be constructed using a number of different MEMS device geometry's for providing the required shutter action. One such type of MEMS geometry for this purpose is the flipping shutter type of MEMS, as available from Flixel Ltd., of Tel Aviv, Israel. Such a flipping pixel array is made up of an array of addressable hinged shutters which can open to an out-of-plane angle of 90° or more, though 90° is optimal for most optical transmission devices. Such devices provide a fill factor of up to 90%.

A further type of MEMS geometry suitable for use in the MEMS Fourier plane SLM of the present invention, is that developed at the NASA Goddard Space Flight Center, for use in the NIR Spectrometer of the Next Generation Space Telescope (NGST), and as described in the article entitled “Programmable 2-Dimensional Microshutter Arrays” by S. H. Moseley et al, published in the ASP Conference Series, Vol. XXX, 2000. An array using this geometry uses a double layer of shutters, each layer of shutters being hinged at opposite ends, and in which the opening mechanism is actuated by selection of the appropriate shutter or shutters by means of micro-motion of an actuation element to latch the edge of the shutter(s) to be opened, followed by macro-motion of the entire array to open the preselected shutter(s).

Another suitable type of MEMS geometry for this use is what is known in the art as the electrostatically operated artificial eyelid device, such as described in U.S. Pat. No. 6,456,420 for “Micromechanical elevating structures” to S. Goodwin-Johansson, and as supplied by MCNC Research and Development Institute of Research Triangle Park, N.C. 27709, or as described in U.S. Pat. No. 5,784,189 for “Spatial light modulator” to C. Bozler et al., as developed at the MIT Lincoln Laboratory, of Lexington, Mass. The artificial eyelid generally has one flexible electrode in the form of a curled flexible film, the curled nature of the film generally being created by an inbuilt stress, and a second flat electrode fixed in the substrate. The curled lid is attached to a window in the substrate at one of the edges of the window, and insulating films preferably cover at least the flat electrode to prevent direct contact between the two electrodes when the lid is rolled out. When a voltage is applied between the two electrodes, electrostatic attraction is established between the rolled up eyelid electrode and the flat substrate electrode. As the electrostatic force overcomes the material rigidity, the flexible film begins to unroll until the entire flap is rolled out against the substrate. Upon the removal of the applied voltage, the inbuilt stress in the flexible film curls it back into its original shape. Operation is achieved at readily attainable operating voltages, with low power consumption and at high speed. Arrays of such actuators can be readily fabricated by standard microelectronic fabrication techniques, and the elements of such an array can either be activated together or they can be individually addressed. Individually addressable artificial eyelids arrays can be used as a programmable Fourier plane filter in wafer inspection systems with visible and/or ultraviolet dark field illumination. Each of the eyelids can be set to one of two states: an “open” or transparent state, in which the flap is rolled up, and a “closed” or opaque state, in which the flap is rolled out. The individual eyelids are preferably controlled from the wafer inspection system controller in order to provide the desired pattern to block the Fourier diffraction spots arising from the repetitive features on the wafer.

A magnetically actuated artificial eyelid MEMS device has been described in U.S. Pat. No. 6,226,116 for “Magnetic micro-shutters” to D. R. Dowe et al., and assigned to the Eastman Kodak Company of Rochester, N.Y.

Spatial light modulator arrays generally have dead areas between the individual pixels, where the transmission of the light does not follow the transmission being selected for the adjacent pixel. The effect of such dead areas is to reduce what is known as the fill-factor of the array. In the case of a pivoting MEMS device, such as the Flixel shutters or the NASA NGST shutters, this dead area is the region occupied by the frame in which the MEMS is installed, and particularly, the pivoting or actuating mechanism by which the MEMS shutter is operated. In the case of the artificial eyelid MEMS device, this dead area arises from the area covered by the rolled up eyelid flap when the MEMS is open. In the above-described MEMS devices, the dead area blocks transmission of light even when the adjacent pixel is switched to be open.

Even LCD SLM arrays have dead areas between the pixels of the array. In such LCD arrays, there are dead areas, generally on one side of each pixel, to contain the on-board transistors for switching the pixels, and often also the conduction leads for the electrodes. There are also dead areas formed in the regions where the actuating electrodes over the LCD layer are absent in order to divide the LCD layer up into its separate pixels, but these are generally very narrow. In the case of LCD arrays, the dead area is not necessarily a completely opaque area, but can be an area with a different and unswitchable transmission from the active area of the pixel. The dead area for an LCD array is thus properly described as an area which does not behave in tandem with the operation of its adjacent pixel.

According to a further preferred embodiment of the present invention, there is provided a novel, double layer SLM, in which the fill factor is increased in comparison to a single layer SLM using the same devices. The SLM arrays of this double SLM array are essentially identical, and are arranged one on top of the other and in close proximity, such that the light to be spatially modulated has to pass serially through both of the individual arrays. The double SLM array relies for its operation on the asymmetric placement of the dead area within each pixel. Two conditions are necessary for the correct operation of the double layered SLM embodiment of the present invention. Firstly, the individual arrays are laterally positioned such that their dead areas are collinearly located in relation to the light transmission through the array. Secondly, the direction of symmetry of the pixel devices in one SLM array is opposite to that of the other array, such that the pixels of the two arrays open in opposite directions. Thus, if for example, in one of the arrays, the dead areas are on the left hand sides of the pixels relative to the direction of propagation of the light beam passing therethrough, then the other array is rotated such that the equivalent dead areas are on the right hand sides of the pixel. Each layer is thus arranged to open in the opposite direction to the other, with the result that the co-positioned overlapping dead areas are common to both layers, thus increasing the overall fill factor. The blocked dead area associated with a single pixel in a single SLM array, thus suffices, at least to a first order approximation, for two pixels in the double SLM array of the present invention.

For optimum fill factor, the pixels in each array are preferably spaced apart by a distance equal to twice the spacing that would be required on an equivalent single SLM array using identical pixel devices. The area thus covered by adjacent pixels is maximized relative to the size of each pixel and each dead area. If the pixels are closer, then there is a superfluous overlap between the active switched areas of the double array. If the pixels are spaced further apart, then there will be an unswitched open gap between the active switched areas of the double array.

There is thus provided in accordance with a preferred embodiment of the present invention, an optical inspection system for inspecting a sample, comprising a light source for directing an incident light beam onto the sample, an objective element having a back focal plane and operative to form an image of the sample from light collected from the sample, and a programmable spatial filter positioned at the back focal plane, the programmable spatial filter comprising an array of Micro-Electro-Mechanical System (MEMS) devices, at least some of the MEMS devices having switched configurations which are alternately generally optically transmissive and optically blocking. The above described optical inspection system preferably also comprises an image analyzer module for analyzing the image and for switching devices of the MEMS array accordingly, such that at least light collected from the sample at selected angles of scattering is blocked. This light collected from the sample at selected angles of scattering generally arises from selected features of the sample, and the selected angles of scattering are preferably predetermined diffraction orders. In this preferred embodiment of the optical inspection system, these predetermined diffraction orders are such as arise in general from repetitive features of the sample.

In accordance with yet other preferred embodiments of the present invention, the light source of the system may be a visible light source, or an ultra-violet light source.

There is further provided in accordance with yet more preferred embodiments of the present invention, an optical inspection system for inspecting a sample, as described above, in which at least one of the MEMS devices is an artificial eyelid device, or a hinged flap device, or a double shutter flap device.

In accordance with still another preferred embodiment of the present invention, there is provided a method of optically inspecting a sample, comprising the steps of, illuminating the sample with a beam of incident light, forming an image of the sample by means of an objective element, the objective element having a back focal plane, positioning at the back focal plane, a programmable spatial filter comprising an array of Micro-Electro-Mechanical System (MEMS) devices, at least some of which have switched alternate configurations which are generally optically transmissive and optically blocking, and adjusting the programmable spatial filter to a pattern such that information related to selected features of the sample is blocked. The pattern is preferably obtained by analysis of an image of the light distribution at the back focal plane to determine light arising from the selected features of the sample and scattered at specific angles. In this case, the specific angles preferably correspond to predetermined diffraction orders, and the selected features of the sample are preferably repetitive features of the sample.

In accordance with yet other preferred embodiments of the present invention, the light may be in the ultra violet spectral range, or in the visible spectral range.

There is further provided in accordance with further preferred embodiments of the present invention, a method of optically inspecting a sample, as described above, in which at least one of the MEMS devices is an artificial eyelid device, or a hinged flap device, or a double shutter flap device.

In accordance with a further preferred embodiment of the present invention, there is also provided a filter for controlling the spatial transmission of a light beam, comprising at least a first optical shutter comprising a section switchable between optically transmissive and optically blocking states, and an unswitchable dead area, and at least a second optical shutter comprising a section switchable between optically transmissive and optically blocking states, and an unswitchable dead area, wherein the at least second optical shutter is disposed in the path of the light beam serially to the at least first optical shutter and is aligned such that in the path of the light beam, the dead area of the at least second optical shutter overlaps the dead area of the at least first optical shutter, and the at least first and at least second optical shutters are mutually aligned such that in a plane perpendicular to the light beam, the switchable section of the at least first optical shutter and the switchable section of the at least second optical shutter face opposite directions relative to the overlapping dead areas.

In accordance with a further preferred embodiment of the present invention, there is also provided a filter for controlling the spatial transmission of a light beam, comprising at least a first optical shutter comprising a section switchable between optically transmissive and optically blocking states, and an unswitchable dead area, and at least a second optical shutter comprising a section switchable between optically transmissive and optically blocking states, and an unswitchable dead area, wherein the at least second optical shutter is disposed in the path of the light beam serially to the at least first optical shutter and is aligned such that in the path of the light beam, the dead area of the at least second optical shutter overlaps the dead area of the at least first optical shutter, and the at least first and at least second optical shutters are mutually aligned with their planes generally parallel, and rotated in the planes at essentially 180° to each other.

In either of the above-described filters, the at least first optical shutter may preferably be part of a first array of optical shutters, and the at least second optical shutter may preferably be part of a second array of optical shutters. The optical shutters are preferably arranged in rows in the arrays. In such a case, the optical shutters are preferably linearly disposed in the rows of the arrays such that the dead areas are spaced apart a distance equal to approximately twice the length of the switchable sections.

In accordance with other preferred embodiments of the present invention, at least some of the optical shutters may be MEMS devices. In this case, the MEMS devices may be flap devices which open generally at right angles to the planes of the devices. The flap devices of the first array and the flap devices of the second array flip then preferably open in opposite directions.

Alternatively and preferably, the MEMS devices may be artificial eyelid devices which open generally along the planes of the arrays. The artificial eyelid devices of the first array and the artificial eyelid devices of the second array then preferably roll open in opposite directions.

In accordance with another preferred embodiments of the present invention, at least some of the optical shutters of the filter may be LCD devices.

Furthermore, in any of the above-described filter devices for controlling the spatial transmission of a light beam, the light beam may preferably be a visible light beam or an ultra-violet light beam.

### BRIEF DESCRIPTION OF THE DRAWINGS

The present invention will be understood and appreciated more fully from the following detailed description, taken in conjunction with the drawings in which:

FIG. 1 illustrates schematically the dark field illumination system of a wafer inspection system utilizing a MEMS Fourier plane filter, according to a first preferred embodiment of the present invention;

FIG. 2 illustrates schematically an electrostatically actuated flexible film MEMS shutter of the artificial eyelid type, such as may preferably be used in the MEMS Fourier plane filter array of FIG. 1;

FIG. 3 is a plan view of a single eyelid MEMS pixel element of the type shown in FIG. 2;

FIGS. 4A to 4C illustrate schematic cross sectional side views of the single eyelid MEMS pixel element shown in FIG. 2, with three different values of the overhang dimension;

FIG. 5 is a schematic illustration of a double array configuration of MEMS eyelid pixels, mutually arranged one on top of the other in a predetermined manner, according to a further preferred embodiment of the present invention;

FIGS. 6A to 6F are schematic plan views of the upper and lower arrays of FIG. 5, and an assembly of both of the arrays, illustrating how correct positioning of the arrays results in an increased fill factor for the complete assembly, according to another preferred embodiment of the present invention; and

FIG. 7 is a schematic block diagram outlining the main steps of the procedure whereby a programmable spatial light modulator can be programmed to adjust itself to follow the area being inspected on the wafer under inspection, such that the correct repetitive or other features to be blocked at each area, are filtered out in accordance with the area under inspection at that point of the inspection procedure.

### DETAILED DESCRIPTION OF PREFERRED EMBODIMENTS

Reference is now made to FIG. 1, which illustrates schematically the dark field illumination system of a wafer inspection system utilizing a MEMS Fourier plane filter, according to a first preferred embodiment of the present invention. The light source 10, which can be non-parallel, is incident on the wafer 12 under inspection. The scattered light 14 from the wafer features is imaged by the objective lens 15. At the back focal plane 16 of this lens, which is the Fourier plane, there is generated a patterned array of spots 18 representing the repetitive features of the wafer being imaged by the scattered light. In the interstitial positions 20 between these spots, there may appear any light scattered from non-repetitive features on the wafer die, such as from a defect which it is desired to detect. A mask 24, preferably comprising a spatial light modulator (SLM) preferably made up of an array of MEMS shutters, is disposed at the Fourier plane 16. The individual MEMS elements of the array are programmed such that the elements 26 opposite the patterned array of spots 18 representing the repetitive features of the wafer being imaged by the scattered light, are closed, thereby blocking passage of these spots to the detection system. On the other hand, the elements 28 not opposite the positions of the patterned array of spots, are programmed to be open, thus allowing scattered light 22 from defects present on the wafer die to pass the Fourier plane, and to be imaged and detected by the system, without interference from the expected repetitive features of the wafer die. The system control system can change the open/close pattern of the array according to the nature of the repetitive regions of the wafer being imaged. In the system illustrated in FIG. 1, the MEMS shutters of the SLM disposed at the Fourier plane have been represented schematically by generically open or closed pixel positions. It is to be understood, though, that the elements may be any sort of MEMS device that provides switchable open and closed transmission paths through the device, whether of a single shutter, multiple shutter or eyelid design, or any other suitable MEMS construction.

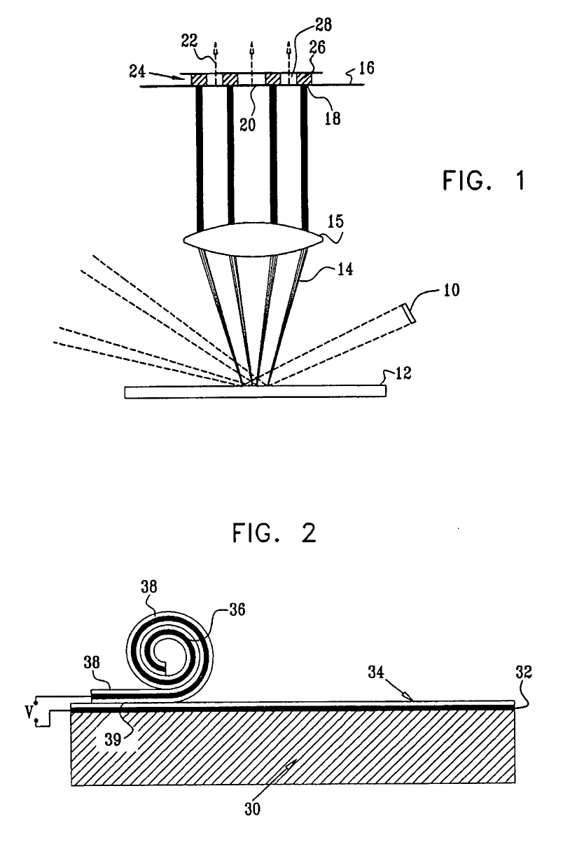

Reference is now made to FIG. 2 which illustrates a cross-sectional schematic drawing of an electrostatically actuated flexible film MEMS shutter of the artificial eyelid type, such as may preferably be used in the Fourier plane MEMS filter array shown in FIG. 1, according to a further preferred embodiment of the present invention. The substrate 30 of the MEMS element, preferably made of fused silica or any similar UV-transmissive material suitable for processing by micro-electronic fabrication techniques, has a conductor 32 deposited on it, and a layer 34 of insulating material to prevent the conductor from being shorted out to the flap when unfurled. The eyelid flap itself is preferably made of a curled-up flexible film electrode 36, which can optionally be coated on either or both of its sides by an insulating polymer film 38. The eyelid flap is preferably attached to the substrate at one edge 39. When a voltage V is applied between the two electrodes, 32, 36, the electrostatic force generated between the electrodes overcomes the material rigidity and the curled-up flexible film unrolls until the entire flap is rolled out onto the substrate. Upon the removal of the applied voltage, the internal predetermined stress in the flexible film curls it back into its original shape. If the artificial eyelid MEMS mechanism is of the magnetic type, the actuation method will be accordingly different.

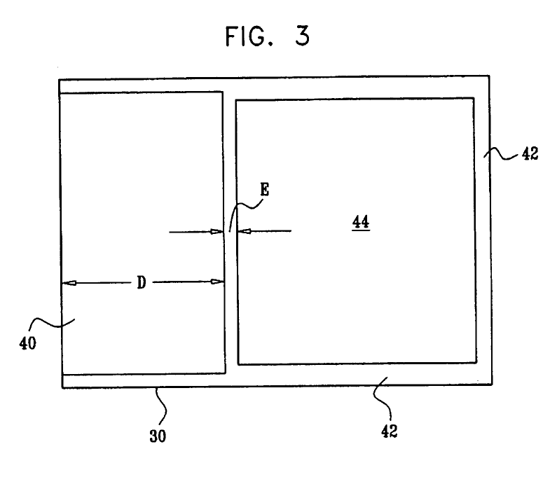

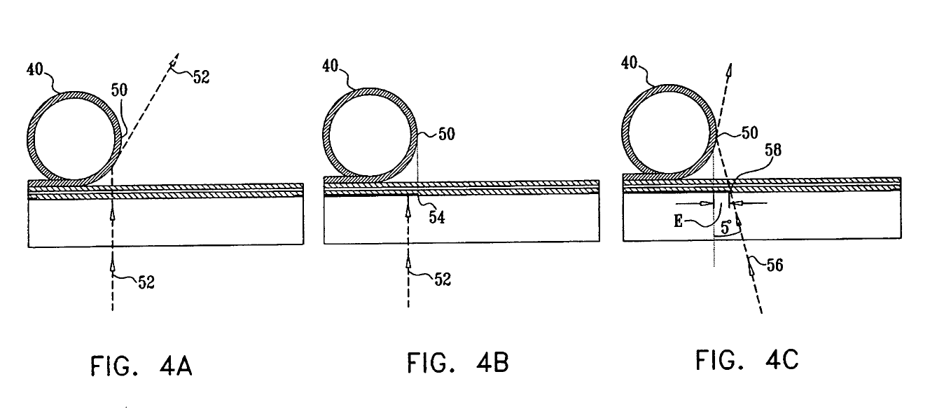

Reference is now made to FIG. 3, which is a plan view of the substrate area 30 of a single eyelid MEMS pixel element of the type shown in FIG. 2, according to another preferred embodiemnt of the present invention. The substrate 30 has an optical opening 44 over a major part of its surface, surrounded by a peripheral frame structure 42. The rolled-up flexible film 40 is stowed at one end of the substrate, ready for spreading out over the optical opening 44 when the shutter is to be closed. The electrode 32 over this opening 44 is preferably made of a transparent conductive material, such as Indium Tin Oxide, ITO, so that the optical transmission through the opening 44 is not curtailed seriously. The curvature diameter D of the curled-up flexible film defines the minimum dead area of the element in the film unfurling direction, and hence the fill factor of the element in that direction. This minimum dead area is typically 100 to 120 microns, and is made up of a minimum core diameter together with the number of curled up flap thicknesses, depending on the length of the flap. The width of the surround 42, generally defined by a metallic frame, determines the fill factor in the orthogonal direction. The outermost edge of the curled-up flexible film is arranged to be somewhat short of the edge of the pixel opening 44, by a small measure E. The reason for this small overhang E is explained with reference to FIGS. 4A to 4C below.

Reference is now made to FIGS. 4A to 4C, which illustrate schematic cross sectional side views of the single eyelid MEMS pixel element shown in FIG. 3, with three different values of the overhang dimension E. In FIG. 4A, no overhang is provided, and the edge of the pixel opening is defined by the outermost rolled-up edge 50 of the stowed flexible electrode 40. In this situation, stray light 52 can be reflected off the edge of the curled up electrode flap, and thus cause disturbance or interference to the imaging light transmitted through the pixel opening. In order to prevent this, in FIG. 4B there is shown a method of preventing such stray light by arranging that the edge 54 of the pixel opening frame is exactly beneath the outermost rolled-up edge 50 of the stowed flexible electrode. Normally incident light 52 is then blocked from the edge 54 of the pixel opening and inwards towards the curled-up flexible electrode. However, since light 56 can also pass through the pixel opening at up to a certain angle relative to the normal, depending on the configuration of the inspection tool, such that it may impinge on the curled-up flexible electrode even with the frame opening exactly above the curled-up electrode outermost edge, in FIG. 4C is shown a more preferable situation in which a small overhang E is provided, such that the pixel opening edge 58 extends further inward than the curled-up electrode outermost edge 50. Only incident light impinging at an angle larger than that determined by the value of E can be scattered by the curled-up electrode edge, and E is selected to ensure that such incidence is of very low likelihood.

To obtain high transmission and to avoid interference effects arising from the illumination incident on the grating array formed when all the pixels are “open”, a high fill factor is required. Since each pixel has a certain minimum “dead area” due to the minimal curvature diameter into which it is possible to roll up the flap, however small, this implies that in order to increase the fill factor, large pixels are required. However, pixels that are too large limit the resolution of the device, and as a result a larger area than desired will be blocked in the Fourier plane, leading to a decrease in the amount of light gathered from potentially detectable defects. Therefore, in order to increase the fill factor of the SLM without reducing the resolution, pixels with smaller dead areas are desired.

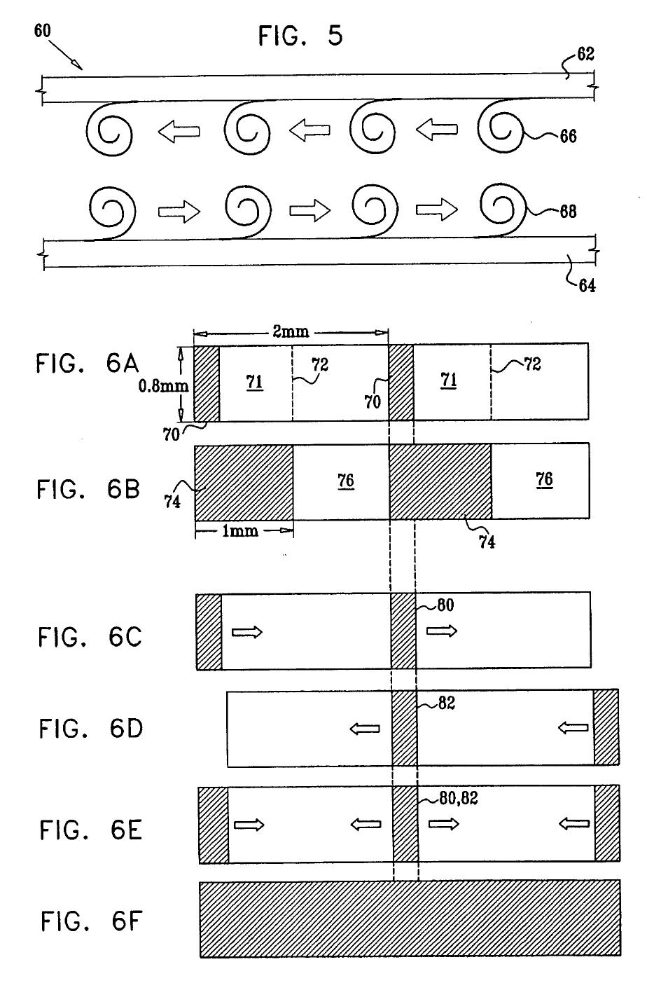

The extent of the dead areas in the preferred examples of the eyelid pixels shown in FIGS. 2 to 4 are such that the fill factors are only of the order of 60% to 65%. In order to increase this fill factor to achieve more advantageous SLM characteristics for the Fourier plane array, reference is made now to FIG. 5, which is a schematic sectional side view of a double array 60 of MEMS pixels, each array mutually positioned and arranged relative to the other in a predetermined manner according to a further preferred embodiment of the present invention, such that the overall fill factor of the double array is increased compared with that of each single array.

In the preferred embodiment of FIG. 5, there are two arrays of generally identical eyelid MEMS, a top array 62 and a bottom array 64. It is to be understood that the terms “top” and “bottom” are not meant to signify specific absolute positions, but are used for illustrative purposes only to describe the mutual positions of the two arrays in the drawing of FIG. 5, for the purpose of explaining the operation of this embodiment of the invention. In practice, the two arrays may be aligned absolutely in any desired orientation, on condition that the illumination passing therethrough traverses through both arrays in a direction generally perpendicular to the plane of the arrays. The two arrays are aligned such that the locations of the curled-up eyelids of the top array fall exactly over the locations of the curled-up eyelids of the bottom array, when the illumination is defined as traversing from top to bottom of the drawing or vice versa. However, the two arrays are mutually disposed in opposite directions, meaning that the curled-up eyelid flaps on each array unfurl in opposite directions. In the preferred embodiment shown in FIG. 5, the eyelids 66 of the top array unfurl from right to left of the drawing, and those 68 of the bottom array from left to right, as indicated by the directional arrows.

Reference is now made to FIGS. 6A to 6F which are schematic plan views, according to another preferred embodiment of the present invention, of the upper and lower arrays of a complete double SLM assembly, and of the complete double-SLM assembly, such as that shown in FIG. 5 for the case of the eyelid MEMS pixels. FIGS. 6A to 6F illustrate how correct positioning of the arrays and the pixels within each of the arrays, results in an increased fill factor for the complete assembly, over that of a single array, according to this preferred embodiment of the present invention. Though FIGS. 6A to 6F have been presented and described generally in terms of the eyelid MEMS elements of FIG. 5, it is to be understood that they are equally applicable to any form of double SLM assembly having pixels with a dead area at one side of the pixel, whether of MEMS, LCD or any other suitable implementation. FIGS. 6A and 6B show two pixels of the bottom array of the double SLM assembly. FIG. 6A shows the flaps of the elements curled-up, each area 70 being the dead area, and each area 71 being the active area of the pixel, with the dotted line 72 showing the extent of the flaps along the array when unfurled. If the double SLM array was one using flap MEMS elements, then the dead area 70 would be the region where the flap hinge and actuating mechanism are located, while the clear area 71 would be the area opened or closed for transmission by the flap itself. If the double SLM array was implemented using pixelated LCD arrays, then the dead area 70 would be the area in which the switching circuits are formed, and the clear area 71 would be the active switchable LCD area through which transmission takes place. These alternative and preferred embodiments are understood to apply equally to this implementation of the present invention as described in the following FIGS. 6B to 6F, which are shown for the eyelid MEMS case. FIG. 6B shows the flaps unfurled 74, and covering approximately half of the length between pixels. The other half 76 of the area of the region between two adjacent pixels remains open, and transmission therethrough is modulated by the devices of the top SLM array, working in conjunction with those of the bottom SLM array, as will be illustrated in FIGS. 6C to 6F hereinbelow. The typical dimensions of a single eyelid MEMS element, 1 mm.×0.8 mm., are also shown in FIGS. 6A and 6B.

According to this preferred embodiment of the present invention, transmission of light through the open half 76 of the length between two pixels is shuttered by means of closure of the flaps or the active area of the second array of the pair, such that the serial combination of the two arrays ensures that the illumination is completely blocked along the whole of the array.

Reference is now made to FIGS. 6C to 6F, which illustrate how correct mutual longitudinal positioning of the arrays results in an increased fill factor for the complete assembly, over that of a single array. FIG. 6C is a view of the lower array, as shown in FIG. 6A, but showing the direction of unfurling of the flaps, in this case to the right. The curled-up flap in the center of the drawing is designated as the dead area 80. The upper array shown in FIG. 6D, whose flaps unfurl to the left, is aligned such that the curled-up flaps, such as the one shown as the dead area 82, are aligned collinearly in the optical illumination path, with the dead area of the lower array. This is shown by the dotted lines between the dead areas 80 and 82. In FIG. 6E is shown the combination of the upper and lower arrays, wherein it is seen that the curled-up flaps 80 and 82 are coincident along the optical illumination path perpendicular to the arrays, and open in opposite directions. Finally, in FIG. 6F is shown both flaps deployed such that the entire array is in a blocking state. In order to ensure complete blockage of the illumination, each of the flaps should preferably extend to fractionally over half of the distance between curled-up flaps. This can be ensured by arranging the spacing between adjacent pixels in each array to be equal to, or very slightly more than, twice the spacing that would be required on an equivalent single SLM array using identical pixel devices. The area thus covered by a pair of adjacent pixels, one in the top array and one in the bottom array, is then maximized relative to the size of each pixel and each dead area. If the pixels of each array are closer, then there is a superfluous overlap between the active switched areas of the double array. If the pixels are spaced further apart, then there will be an unswitched open gap between the active switched areas of the double array.

When the pixels used are other flap-type MEMS, or LCD pixels, then an equivalent explanation applies with the dead area of the pixels in the top and the bottom arrays being arranged collinearly and in mutually opposite directions.

Since according to the above-described preferred embodiment of the present invention, the dead spaces of the arrays are arranged one on top of the other, the total dead space taken in each double array assembly is reduced to half of that of a single array, since the position taken by the dead space of one array is in the same position serially in the light illuminating beam path as that of the other array. This preferred double array embodiment thus reduces the dead space by approximately half, with a commensurate increase in fill factor. Thus, for instance, if the fill factor for a specific design of single eyelid MEMS array is 60%, then for the double array embodiment of the present invention, it may be increased to close to 80%.

According to further preferred embodiments of the present invention, various methods are provided whereby programmable spatial filters can be utilized in wafer inspection systems for dynamically blocking diffraction orders or other known angular portions of the scattered light, relating to repetitive features or other specific features which it is desired to eliminate from the images of the wafer under inspection. In the above-mentioned co-pending U.S. patent application Ser. No. 10/345,097, there is described a method and apparatus for initially viewing the image obtained in the Fourier plane, in order to learn the Fourier plane topography of preselected regions of the wafer under inspection, and then to actively adapt a spatial Fourier filter design to a specific layer or region or feature of the wafer under inspection in accordance, with the Fourier plane image obtained in the learning stage.

According to these preferred embodiments of the present invention, the various required layouts of the programmable filter, each layout in accordance with the region or set of features which it is desired to eliminate from the image, are stored in advance as part of the inspection protocol or “inspection recipe” for each specific wafer design. Then, during the inspection procedure itself, the programmable SLM is activated to generate each required pattern layout in synchronization to the inspection path being followed by the system. According to this preferred embodiment of the present invention, the programmable filter layout becomes part of the inspection protocol, and each time a wafer having a specific recipe is inspected, the required layout of the filter that was obtained during the pre-inspection learning stage, is activated. This method is applicable using any of the systems and programmable spatial light modulators of the present invention, or of prior art systems.

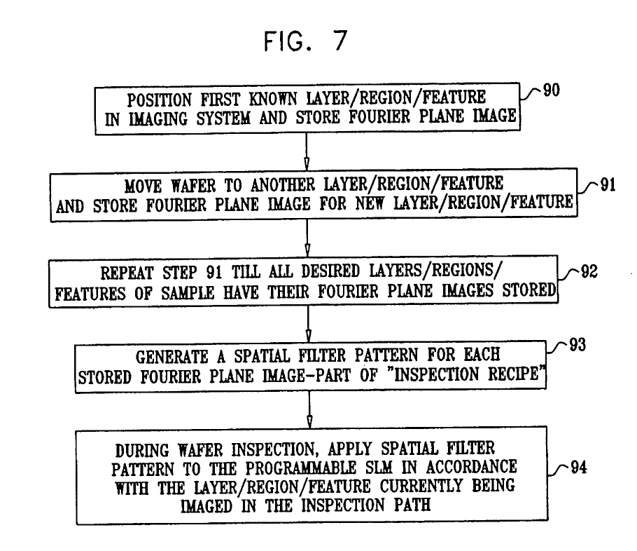

Reference is now made to FIG. 7, which is a schematic block diagram outlining the main steps of the above-described procedure whereby a programmable spatial light modulator can be programmed to adjust itself to follow the area being inspected on the wafer under inspection, such that the correct repetitive or other features to be blocked at each area, are filtered out in accordance with the area under inspection at that point of the inspection procedure.

According to the preferred procedure illustrated in FIG. 7, at step 90, the wafer to be inspected is positioned in the inspection system, with the first known layer, region or feature which it is desired to eliminate from the image when the inspection is performed, positioned under the objective lens. The Fourier plane image of this layer/region/feature is then determined, preferably by use of an auxiliary lens which images the back focal plane of the objective lens onto the imaging detector, and the resulting Fourier plane image of this first layer/region/feature is stored in the system memory.

In step 91, the wafer is then moved to the next known layer, region or feature which it is desired to eliminate from the inspection image, and a second Fourier plane image recorded and correlated to this second known position. According to step 92, this procedure is repeated over the whole wafer, and through all of the required layers thereof, until the complete wafer is “learned”. The resulting Fourier plane images are stored in the control system in step 93, as a series of spatial filter patterns, one for each layer/region/feature of the wafer which it is desired to filter out of the inspection image. This series of spatial filter patterns are thus made part of the inspection protocol or “inspection recipe” for each wafer to be inspected.

Finally, as shown in step 94, each of these spatial filter patters is converted into the correct drive signal information to generate a corresponding spatial filter in the programmable spatial light filter, such as those described in the various preferred embodiments of the present invention. As the inspection path of the wafer is followed, at each known inspection step, the spatial light filter is activated with the corresponding spatial filter pattern so as to filter out the layer/region/feature which it is desired to eliminate from the inspection image, as defined in the predetermined inspection protocol.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. An optical inspection system for inspecting a sample, comprising:
a light source for directing an incident light beam onto said sample;
an objective element having a back focal plane and operative to form an image of said sample from light collected from said sample; and
a programmable spatial filter positioned at said back focal plane, said programmable spatial filter comprising an array of Micro-Electro-Mechanical System (MEMS) devices, at least some of said MEMS devices having switched configurations which are alternately generally optically transmissive and optically blocking.

2. An optical inspection system according to claim 1 and also comprising an image analyzer module for analyzing said image and for switching devices of said MEMS array accordingly, such that at least light collected from said sample at selected angles of scattering is blocked.

3. An optical inspection system according to claim 2 and wherein said light collected from said sample at selected angles of scattering arises from selected features of said sample.

4. An optical inspection system according to claim 2 and wherein said selected angles of scattering are predetermined diffraction orders.

5. An optical inspection system according to claim 4 and wherein said light collected from said sample at predetermined diffraction orders arises from repetitive features of said sample.

6. An optical inspection system according to claim 1 and wherein said light source is a visible light source.

7. An optical inspection system according to claim 1 and wherein said light source is an ultra-violet light source.

8. An optical inspection system according to claim 1, wherein at least one of said MEMS devices is an artificial eyelid device.

9. An optical inspection system according to claim 1, wherein at least one of said MEMS devices is a hinged flap device.

10. An optical inspection system according to claim 1, wherein at least one of said MEMS devices is a double shutter flap device.

11. A method of optically inspecting a sample, comprising the steps of;
illuminating said sample with a beam of incident light;
forming an image of said sample by means of an objective element, said objective element having a back focal plane;
positioning at said back focal plane, a programmable spatial filter comprising an array of Micro-Electro-Mechanical System (MEMS) devices, at least some of which have switched alternate configurations which are generally optically transmissive and optically blocking; and
adjusting said programmable spatial filter to a pattern such that information related to selected features of said sample is blocked.

12. A method according to claim 11, wherein said pattern is obtained by analysis of an image of the light distribution at said back focal plane to determine light arising from said selected features of said sample and scattered at specific angles.

13. A method according to claim 12, wherein said specific angles correspond to predetermined diffraction orders, and said selected features of said sample are repetitive features of said sample.

14. A method according to claim 11, wherein said light is in the ultra violet spectral range.

15. A method according to claim 11, wherein said light is in the visible spectral range.

16. A method according to claim 11, wherein at least one of said MEMS devices is an artificial eyelid device.

17. A method according to claim 11, wherein at least one of said MEMS devices is a hinged flap device.

18. A method according to claim 11, wherein at least one of said MEMS devices is a double shutter flap device.

19. A filter for controlling the spatial transmission of a light beam, comprising:
at least a first optical shutter comprising a section switchable between optically transmissive and optically blocking states, and an unswitchable dead area; and
at least a second optical shutter comprising a section switchable between optically transmissive and optically blocking states, and an unswitchable dead area;
wherein said at least second optical shutter is disposed in the path of said light beam serially to said at least first optical shutter and is aligned such that in the path of said light beam, said dead area of said at least second optical shutter overlaps said dead area of said at least first optical shutter, and said at least first and at least second optical shutters are mutually aligned such that in a plane perpendicular to said light beam, said switchable section of said at least first optical shutter and said switchable section of said at least second optical shutter face opposite directions relative to said overlapping dead areas.

20. A filter for controlling the spatial transmission of a light beam, comprising:
at least a first optical shutter comprising a section switchable between optically transmissive and optically blocking states, and an unswitchable dead area; and
at least a second optical shutter comprising a section switchable between optically transmissive and optically blocking states, and an unswitchable dead area;
wherein said at least second optical shutter is disposed in the path of said light beam serially to said at least first optical shutter and is aligned such that in the path of said light beam, said dead area of said at least second optical shutter overlaps said dead area of said at least first optical shutter, and said at least first and at least second optical shutters are mutually aligned with their planes generally parallel, and rotated in said planes at essentially 180° to each other.

21. A filter for controlling the spatial transmission of a light beam, according to claim 20 and wherein said at least first optical shutter is part of a first array of optical shutters, and said at least second optical shutter is part of a second array of optical shutters.

22. A filter for controlling the spatial transmission of a light beam, according to claim 21, and wherein said optical shutters are arranged in rows in said arrays.

23. A filter for controlling the spatial transmission of a light beam, according to claim 22, and wherein said optical shutters are linearly disposed in said rows of said arrays such that said dead areas are spaced apart a distance equal to approximately twice the length of said switchable sections.

24. A filter for controlling the spatial transmission of a light beam, according to claim 19, and wherein at least some of said optical shutters are MEMS devices.

25. A filter for controlling the spatial transmission of a light beam, according to claim 24, and wherein said MEMS devices are flap devices which open generally at right angles to said planes of said devices.

26. A filter for controlling the spatial transmission of a light beam, according to claim 25, and wherein said flap devices of said first array and said flap devices of said second array flip open in opposite directions.

27. A filter for controlling the spatial transmission of a light beam, according to claim 24, and wherein said MEMS devices are artificial eyelid devices which open generally along said planes of said arrays.

28. A filter for controlling the spatial transmission of a light beam, according to claim 27, and wherein said artificial eyelid devices of said first array and said artificial eyelid devices of said second array roll open in opposite directions.

29. A filter for controlling the spatial transmission of a light beam, according to claim 19 and wherein at least some of said optical shutters are LCD devices.

30. A filter for controlling the spatial transmission of a light beam according to claim 19 and wherein said light beam is a visible light beam.

31. A filter for controlling the spatial transmission of a light beam according to claim 19 and wherein said light beam is an ultra-violet light beam.
